(19) United States
(12) Patent Application Publication
(10) Pub. No.: US 2006/0076802 A1
(43) Pub. Date: Apr. 13, 2006

(54) Vehicle gate with detachable window

(75) Inventor: Randall Voelkert, Richmond, MI (US)

Correspondence Address: BAKER & DANIELS LLP, 300 NORTH MERIDIAN STREET, SUITE 2700, INDIANAPOLIS, IN, 46204, US

(73) Assignee: ByTec, Inc.

(21) Appl. No.: 11/249,548

(22) Filed: Oct. 13, 2005

Related U.S. Application Data
(60) Provisional application No. 60/618,520, filed on Oct. 13, 2004.

(51) Int. Cl. B60J 7/00

(52) U.S. Cl. 296/190.11

(57) ABSTRACT

A gate assembly for a vehicle that includes a gate, a window having a pane that is retractable within the gate, and an attachment mechanism releasable attaching the window to the gate. The gate assembly has a first position, wherein the gate is upright and the window is attached to the gate, a second position wherein the gate is down and the window is attached to the gate, and a third position wherein the gate is down and the window is detached from the gate and located in a window opening in the vehicle. The window may include a frame, and the pane may be extended above the gate in the first position to cover the window opening in the vehicle. The gate assembly may also include a fourth position wherein the gate is upright, the window is attached to the gate, and the pane is retracted within the gate. The gate assembly may further include a regulator system that moves the pane from a retracted position within the gate to an extended position extending above the gate. In one embodiment, the attachment mechanism attaches the window to the gate when a slide on the regulator system is moved upward, and a subsequent upward movement of the slide detaches the window from the gate.

### BACKGROUND OF THE INVENTION

The present invention relates to a gate assembly for use on a vehicle, and in particular, to a gate assembly having a power-operated retractable and detachable window.

Pick-up trucks and sport utility vehicles (SUVs) have become very popular. With the increased popularity, efforts have been made to increase the versatility of these vehicles. For instance, pick-up trucks or SUVs have been developed that have extended cabs that are suitable for carrying more than three passengers, which is all standard pick-up trucks can accommodate. However, extended cab configurations generally tend to shorten and reduce the load carrying capacity of the cargo box on the vehicle.

In order to increase the versatility of the vehicle, it has been known to provide an opening or passage between the cab and the cargo box of a pick-up truck for increasing the length of a load that can be carried in the cargo box. One such configuration is shown in U.S. Pat. No. 5,934,727, which is incorporated herein by reference. The '727 patent discloses a configuration for a pick-up truck having a cab portion with a second row of passenger seats. A cargo box is located behind the cab portion, and a box panel is pivotally connected to a front wall of the cargo box and movable to a generally horizontal position. A cab panel is pivotally mounted to the cab portion and is movable between a generally vertical closed position and a generally horizontal open position. When both the box panel and the cab panel are moved to the horizontal position, an opening is formed between the cab portion and the cargo box so that longer loads can be passed through the opening so that a portion of the load is in the cab portion with the remainder in the cargo box.

Another prior art vehicle with a reconfigurable back panel is shown in U.S. Pat. No. 6,416,104, which is incorporated herein by reference. The vehicle disclosed in the '104 patent includes a reconfigurable back panel and window system. A forward compartment communicates with a rear cargo compartment through an access opening in a body frame. A lower closure panel, intermediate crossbar, and upper window optionally close/open to separate the compartments for passenger and cargo use. The window may be removed and stored in the truck, while the panel may be pivoted open to permit varying degrees of communication between the compartments for carrying passengers or cargo as desired.

Although the vehicle disclosed in the '104 patent has various configurations that increase the versatility of the vehicle, the window must be manually removed and placed into a storage area in the panel. It would be desirable and convenient to provide a power-operated retractable window for a gate separating the cargo area and passenger compartment. In particular, it would be desirable if the window could be retracted within the gate for ease in lowering the gate, or alternately, if the window could be automatically disconnected from the gate to provide a rear window to the passenger compartment while still providing a lower opening with the gate down between the cargo compartment and the passenger compartment to facilitate transporting longer loads.

### SUMMARY OF THE INVENTION

In one embodiment of the invention, a gate assembly for a vehicle is provided that includes a gate, a window having a pane that is retractable within the gate, and an attachment mechanism releasably attaching the window to the gate. The gate assembly has a first position, wherein the gate is upright and the window is attached to the gate, a second position wherein the gate is down and the window is attached to the gate, and a third position wherein the gate is down and the window is detached from the gate and located in an opening for the window in the vehicle.

The window may include a frame, and the pane may be extended above the gate in the first position to cover the window opening in the vehicle. The gate assembly may also include a fourth position wherein the gate is upright, the window is attached to the gate, and the pane is retracted within the gate.

The gate assembly may further include a regulator system that moves the pane from a retracted position within the gate to an extended position extending above the gate. The regulator system may include a slide, and the attachment mechanism may include a cam body connected to the slide. The cam body includes a cam member and a coupling unit. The coupling unit may include a resilient member. In one embodiment shown, the attachment mechanism further includes a slide mechanism connected to the window, and the slide mechanism has a cam surface that mates with the cam member and a receiving portion engageable with the coupling unit.

The slide mechanism may further include an engagement member that secures the window in the third position. The cam member may provide movement to the engagement member and move the receiving portion relative to the coupling unit. In one embodiment, when the slide of the regulator system moves upward, the cam member moves the engagement member into place to secure the window in the third position, and after the slide moves downward, a subsequent upward movement of the slide causes the cam member to retract the engagement member and engage the coupling unit with the receiving portion.

The attachment mechanism may further include a slide mechanism connected to the window, and the slide mechanism may have an engagement member that secures the window in the third position. The engagement member may be biased by a resilient member to lock with a frame member of the vehicle to secure the window in the third position. The slide mechanism may further include a pivot arm and a catch member, wherein the window is attached to the gate when the pivot arm is engaged with the catch member, and the window is releasable from the gate when the pivot arm is disengaged from the catch member. In one embodiment, the engagement member is disengaged from the frame member of the vehicle when the pivot arm is engaged with the catch member.

In another embodiment of the invention, a gate assembly for a vehicle is provided that includes a gate, a window having a pane that is retractable within the gate, and an attachment mechanism releasably attaching the window to the gate, wherein the attachment mechanism includes a slide mechanism having a slide body movable between one position attaching the window to the gate to an other position, wherein the window is detached from the gate and the slide body is engaged with the vehicle.

The slide body may be biased by a resilient member to the other position wherein the window is detached from the gate.

In one embodiment, the slide mechanism further includes a housing having a pivot arm attached thereto, and the slide body includes a catch member. The pivot arm may be engaged with the catch member when the slide body is in the one position wherein the window is attached to the gate, and the pivot arm is disengaged from the catch member when the slide body is in the other position wherein the window is detached from the gate.

The gate assembly may include a regulator system having a slide, and the attachment mechanism may include a cam body attached to the slide. The cam body may include a cam member, and the slide body may include a cam surface so that the cam member engages the cam surface to move the slide body between the positions. The cam body may further include a coupling unit, and the slide body may include a receiving portion enjoyable with the coupling unit to secure the window to the gate. The coupling unit may include a resilient member and a pin having an enlarged head. The receiving portion may include a keyhole-shaped slot having a wider portion and a narrower portion, wherein the head on the pin fits through the wider portion but not the narrower portion.

In another embodiment, a gate assembly for a vehicle is provided that includes a gate, a window having a pane that is retractable within the gate, a regulator having a slide that drives movement of the window, and an attachment mechanism releasably attaching the window to the gate. The attachment mechanism may include a cam body connected to the slide, wherein the cam body has a cam member that causes the window to detach from the gate when the slide is moved.

A subsequent movement of the cam member may cause the window to reattach to the gate. In one embodiment, both of the movements of the cam member to detach and to reattach the window to the gate are in an upward direction.

The cam body may further include a coupling unit that attaches the window to the gate. The coupling unit may include a resilient member.

The attachment mechanism may further include a slide mechanism with a slide body, wherein the slide body has a cam surface configured to mate with the cam member and a receiving portion that is enjoyable with the coupling unit. The slide body may further include an engagement member and a resilient member biasing the engagement member to engage a frame on the vehicle. In one embodiment, the slide mechanism further includes a pivot arm mounted on a housing and a catch member on the slide body. The pivot arm and catch member may be engageable to prevent the engagement member from engaging the frame on the vehicle.

In yet another embodiment of the invention, a gate assembly for a vehicle is provided that includes a gate, a retractable window, and an attachment mechanism releasably attaching the window to the gate. The attachment mechanism may include a slide mechanism with a slide body having an engagement member. The slide body may be movable between one position where the engagement member is engaged with the vehicle to secure the window in an opening of the vehicle and another position wherein the engagement member is disengaged from the vehicle with the window being movable relative to the vehicle.

### BRIEF DESCRIPTION OF THE DRAWINGS

FIG. 1 is a perspective view from the rear of a vehicle having a gate assembly of the present invention with the gate in an upright position and a window attached to the gate, and which is extended out into a fully closed position;

FIG. 2 is another perspective view from the rear of the vehicle of FIG. 1 with the gate in the upright position and the window attached but retracted within the gate;

FIG. 3 is another perspective view from the rear of the vehicle of FIG. 1 with the gate in a down position and the window attached to and retracted within the gate;

FIG. 4 is another perspective view from the rear of the vehicle of FIG. 1 with the gate in a down position and the window detached from the gate, yet still attached to the truck cab;

FIG. 5 is yet another perspective view from the rear of the vehicle of FIG. 1 with a portion of the gate removed to show a regulator assembly for moving the window;

FIG. 6 is a perspective view of an attachment mechanism for releasably attaching the window to the gate;

FIG. 7 is a perspective view of the attachment mechanism of FIG. 6 with a cam body of the attachment mechanism separated from a slide mechanism;

FIG. 8A is a partial plan view of the attachment mechanism positioned when the window is attached to the gate;

FIG. 8B is a partial plan view of the attachment mechanism showing a slide body of the slide mechanism pushed to the left for releasing the attachment mechanism;

FIG. 8C is a partial plan view of the attachment mechanism in a position wherein the window is detached from the gate;

FIG. 9A is a cross-sectional view taken where shown in FIG. 8A of the attachment mechanism when the window is attached to the gate;

FIG. 9B is a cross-sectional view taken as shown in FIG. 8B of the attachment mechanism when the slide body is pushed to the left for releasing the attachment mechanism; and

FIG. 9C is a cross-sectional view taken where shown in FIG. 8C of the attachment mechanism in the position wherein the window is detached from the gate.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention which would normally occur to one skilled in the art to which the invention relates.

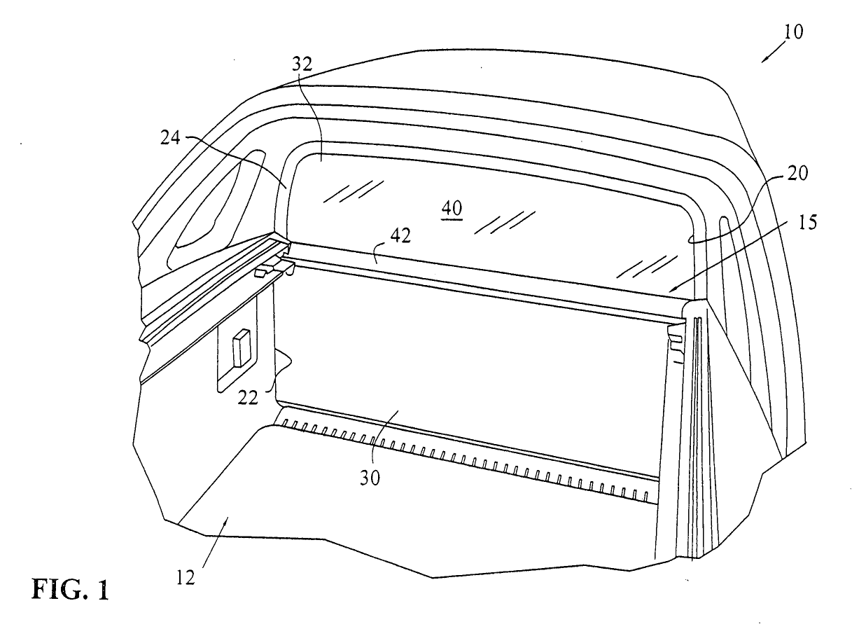

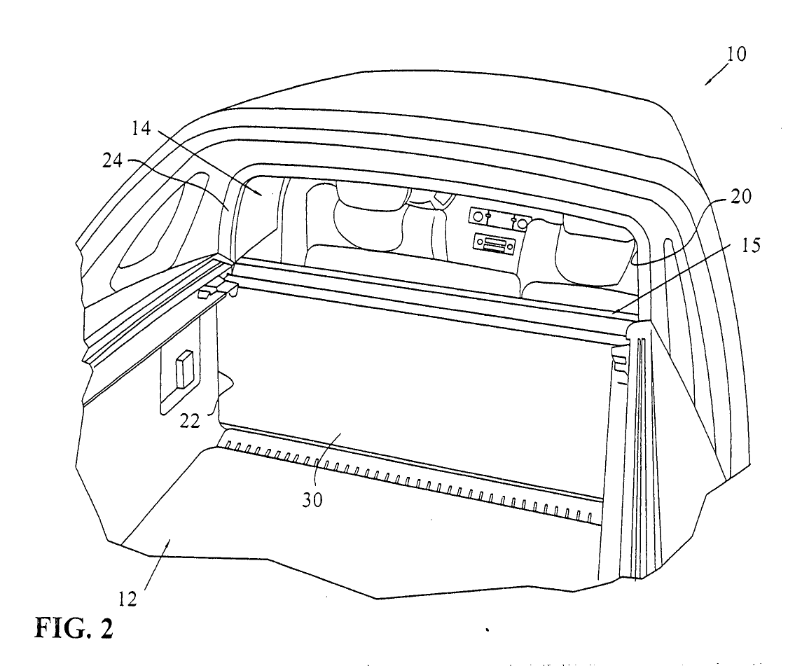

Referring now to FIGS. 1-5, a vehicle, such as a pick-up truck or sport utility vehicle, is shown generally indicated as 10. Vehicle 10 includes a cargo compartment generally indicated as 12 and a passenger compartment generally indicated as 14 (FIG. 2). Separating cargo compartment 12 and passenger compartment 14 is a gate assembly generally indicated as 15.

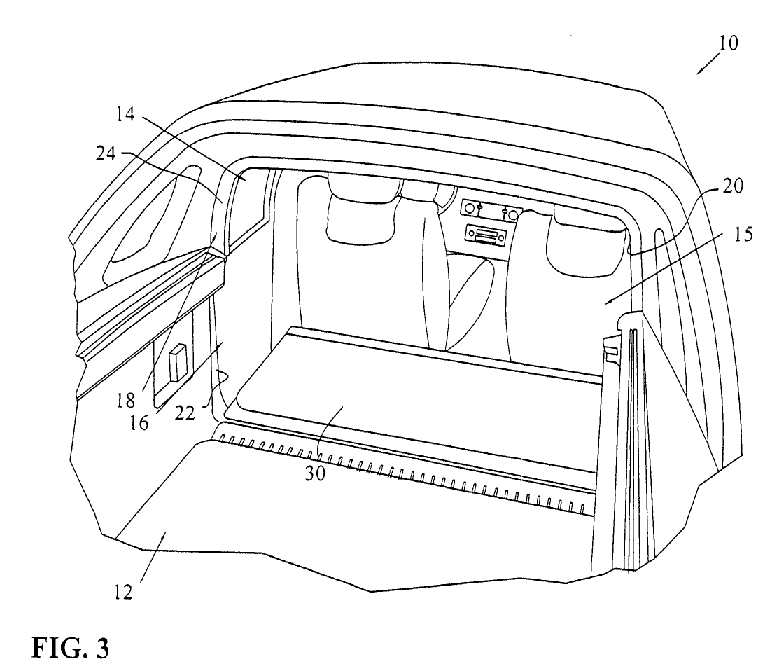

Also located between cargo compartment 12 and passenger compartment 14 is an opening generally indicated as 16, (FIG. 3) wherein gate assembly 15 is located, and which is defined by a peripheral frame generally indicated as 18. Opening 16 includes an upper or window portion 20 and a lower or gate portion 22. Peripheral frame 18 includes a channel portion 24 around the sides and top of the window portion opening 20 for purposes as described below in further detail.

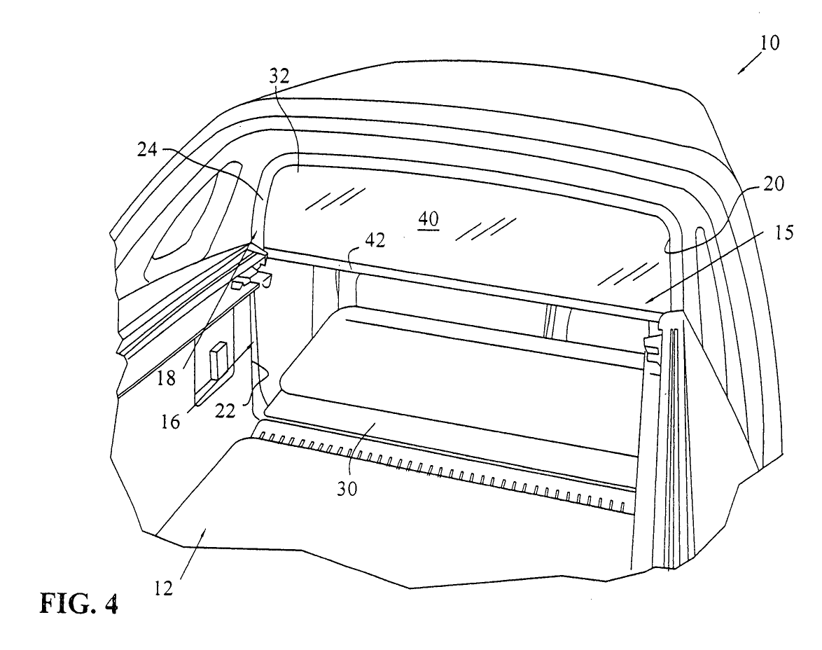

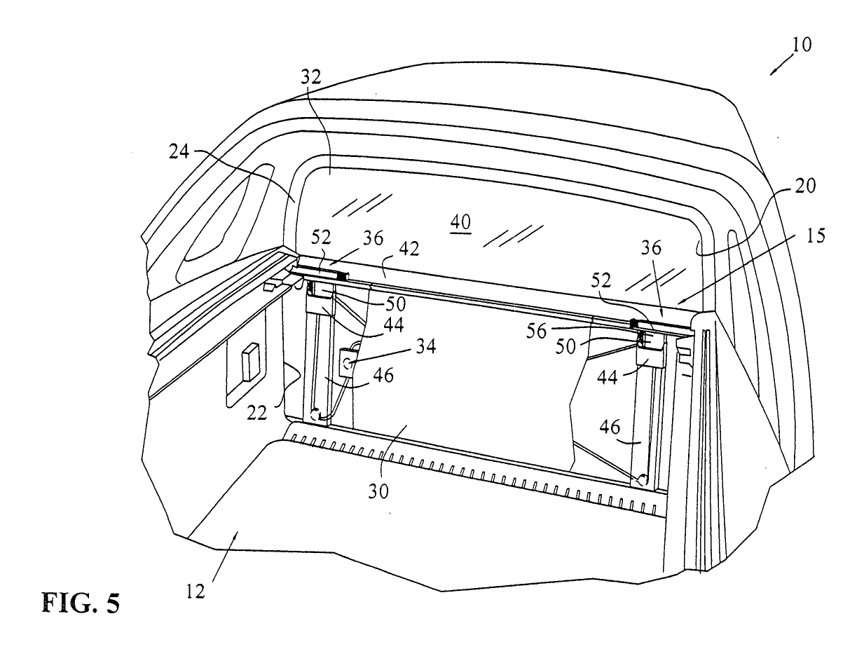

In the embodiment shown, gate assembly 15 includes a gate 30 that is pivotally mounted to peripheral frame 18, a retractable and detachable window 32, a regulator assembly generally indicated as 34 (FIG. 5) for raising and lowering the window, and a pair of attachment mechanisms 36 (FIG. 5) for attaching and detaching the window to the gate. Gate 30 is mounted and operated in a known manner and includes latches (not shown) for latching the gate into an upright position as shown in FIGS. 1, 2 and 5 or for releasing the gate to the down position as shown in FIGS. 3 and 4.

In the embodiment shown, window 32 includes a glass pane 40 and a frame 42. The window is extendable from and retractable into gate 30 as driven by regulator assembly 34. When window 32 is extended upward, the peripheral upper and side edges are received within channel portion 24 of peripheral frame 18. When retracted, window 32 is housed within and protected by gate 30. Regulator assembly 34 is of a known design and includes a pair of slides 44 that extend up and down regulator tracks 46. Slides 44 not only raise and lower window 32 as discussed above, but also drive the attachment and detachment of window 32 to gate 30 as described in detail below.

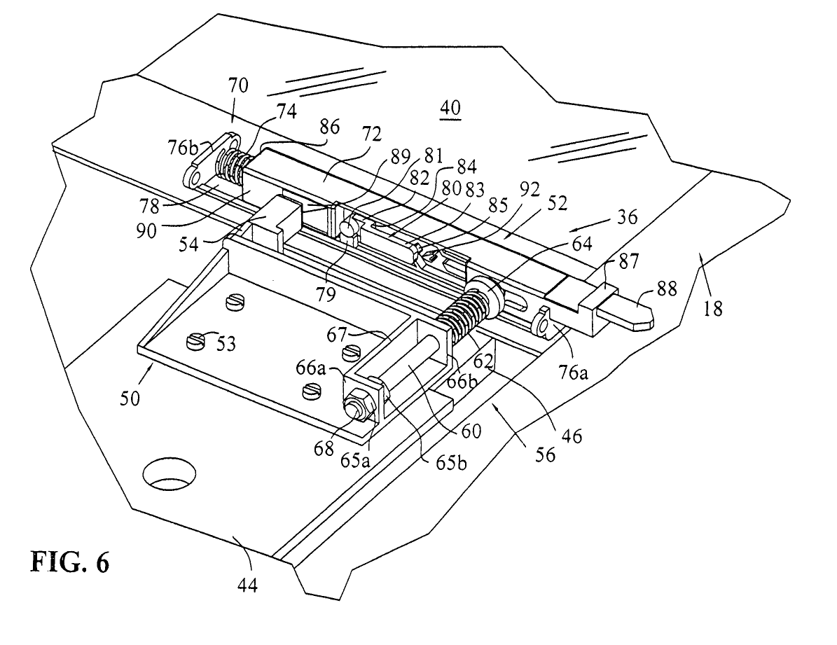

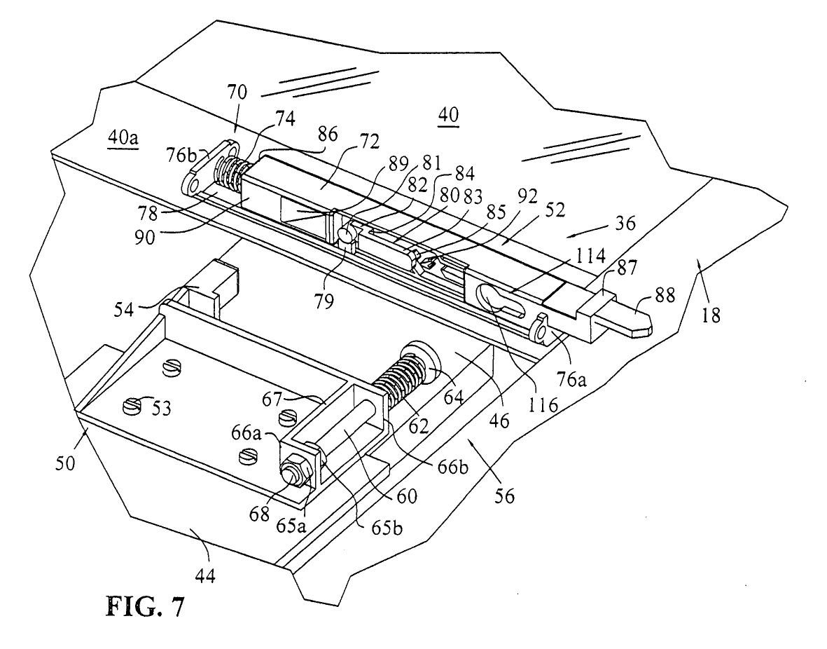

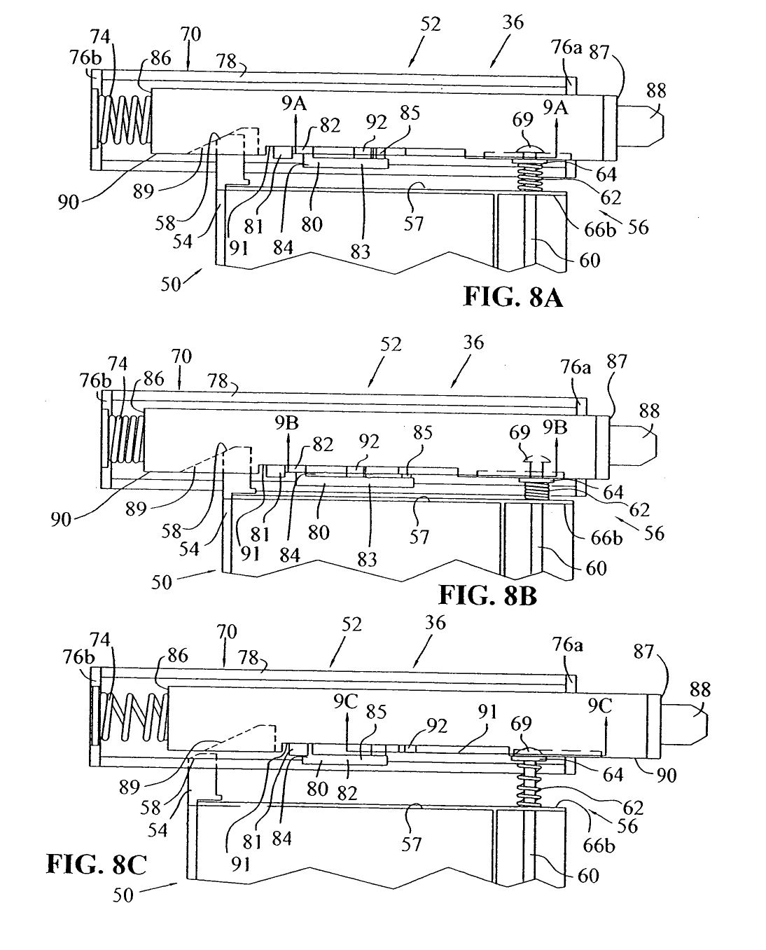

Now referring to FIGS. 6 and 7, one of the attachment mechanisms 36 is shown in greater detail. Each attachment mechanism 36 includes a cam body generally indicated as 50 and a slide mechanism generally indicated as 52. In the embodiment shown, each cam body 50 is attached to one of the slides 44 using screws 53. Cam body 50 includes a cam member or post 54 and a coupling unit generally indicated as 56. Cam body 50 may be molded from a suitable material such as polymer wherein cam member 54 is integrally formed therewith, or can be cast from a metallic composition such as aluminum or other suitable material. Cam member 54 extends upwardly from an upper end 57 of cam body 50 and has a cam surface 58 (FIGS. 8A-8C) at the outer end thereof.

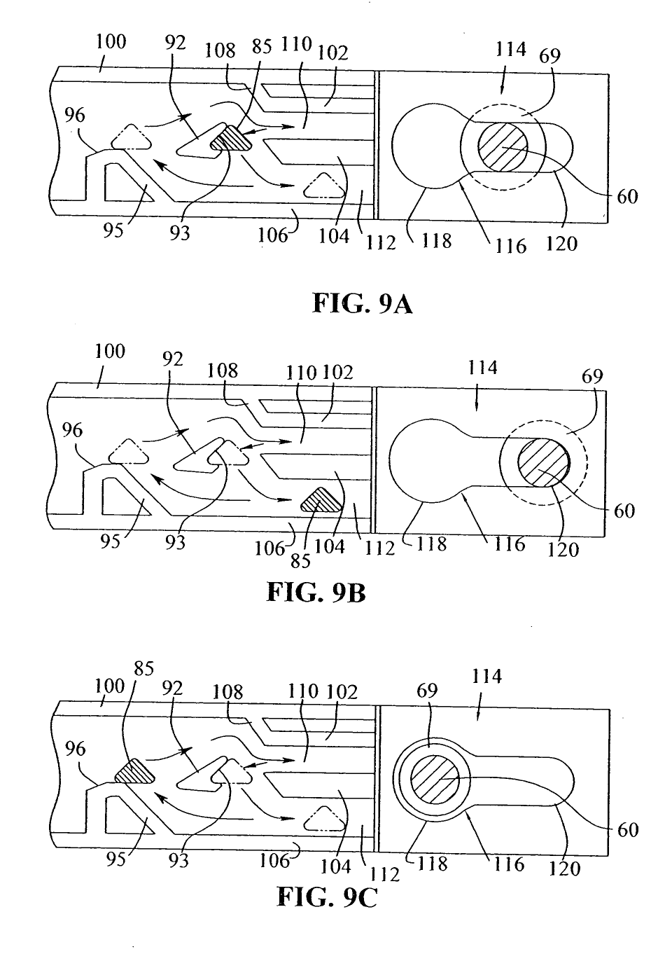

In the embodiment shown, coupling unit 56 includes a pin 60, a resilient member or compression spring 62, a guide washer 64, a pair of nuts 65a, 65b and a pair of mounting tabs 66a, 66b that have through holes and are integrally formed with and extend perpendicularly outward from cam body 50. A support web 67 extends between mounting tabs 66a and 66b and is also integrally formed with and extends from cam body 50 for providing structural support to the mounting tabs. Pin 60 includes a threaded end 68 for receiving nuts 65a and 65b and an opposite end having an enlarged head 69 (FIGS. 8A-8C and 9A-C).

Each slide mechanism 52 includes a slide housing generally indicated as 70, a slide body generally indicated as 72, and a resilient member or compression spring 74 for biasing the slide body relative to the slide housing. Slide housing 70 includes a pair of end walls 76a, 76b and a slide tray 78 having a pivot support 79 extending upward therefrom. Slide body 72 is mounted on and is slidable relative to slide tray 78 as will be discussed in further detail below.

Also attached to slide housing 70 is a pivot arm 80 pivoting about a pivot 81, which is mounted to pivot support 79 on slide tray 78. Pivot arm 80 has a generally Z-shaped configuration including a first leg 82, which is located adjacent slide body 72 and attached to pivot 81, and a second leg 83 spaced apart from but extending substantially parallel to first leg 82 and slide body 72. First leg 82 and second leg 83 are connected by an intermediate leg 84 that extends substantially perpendicular to the first and second legs and slide body 72. Located towards the outer end of second leg 83 is a locking feature 85 that extends inward towards slide body 72. In the embodiment shown in FIGS. 9A-9C, locking feature 85 has a generally triangular-shaped cross-section. It should be noted that in FIGS. 9A-9C, the solid cross-hatched lines of locking feature 85 represent the location the locking feature in that view, while the phantom lines represent other positions as the slide body moves and the arrows show the path that the locking feature moves through.

Slide body 72 has a generally rectangular configuration and includes a first end 86 and a second end 87. Compression spring 74 engages first end 86, and second end 87 has an engagement member or pin 88 extending therefrom for securing window 32 to peripheral frame 18. Slide body 72 also includes a cam surface 89, which in the embodiment shown, is recessed inwardly at a slope from a side 90 of the slide member, as shown best in FIG. 7.

Slide body 72 also has a recessed area 91 (FIGS. 8A-8C) located along side 90, from which a catch member or island 92 is located. The general location of island 92 is best shown in FIG. 7. Island 92 has a wedge-shaped cross-section (FIGS. 9A-9C) that points toward end 86 of slide body 72 and includes a receiving profile 93 configured to engage locking feature 85 as shown in FIG. 9A. Also located on and extending from the bottom surface of recessed area 91 is a ramp 95 having an upper end 96 and a series of parallel extensions 100, 102, 104 and 106. Extensions 100 and 102 are connected by an angled extension 108, and extensions 102 and 104 define a channel 110 therebetween, while extensions 104 and 106 define a channel 112.

As shown in FIG. 7, slide body 72 also includes a receiving portion generally indicated as 114, which in the embodiment shown includes a keyhole-shaped slot 116. As shown in FIG. 9A, keyhole slot 116 has a wider portion 118 and a narrower portion 120. Wider portion 118 is configured to receive enlarged head 69 (FIG. 8A) of pin 60 as is discussed in greater detail below.

To assemble gate assembly 15, cam bodies 50 must be assembled and attached to respective slides 44 and slide mechanisms 52 must be assembled and attached to pane 40 of window 32. To assemble cam bodies 50, guide washer 64 is placed over threaded end 68 and positioned down toward enlarged head 69 of pin 60. It should be noted that the hole (not shown) in the center of guide washer 64 has a diameter large enough so that the majority of pin 60 will fit therethrough; however, the hole is smaller than the diameter of enlarged head 69. Compression spring 62 is then placed on pin 60 and moved against guide washer 64. Spring 62 bears against washer 64 as the diameter of the compression spring is smaller than the outer diameter of washer 64. Threaded end 68 of pin 60 is then inserted through the through hole in tab 66b, and nut 65b is then screwed on threaded end 68. Next, threaded end 68 is inserted through the hole in tab 66a so that nut 65b bears against tab 66a, and nut 65a is screwed on threaded end 68 and tightened against tab 66a to secure the pin 60. It should be appreciated that the position of pin 60 may be adjusted by untightening nuts 65a, 65b and moving them where desired on threaded end 68 and then retightening the nuts against tab 65a. Once cam bodies 50 are assembled, they may be attached to respective slides 44 using screws 53 or other known fasteners or fastening techniques including welding or adhesives.

Slide mechanism 52 is assembled by mounting slide body 72 to be slidable within slide tray 78 using a tongue and groove feature (not shown) or other known means to provide relative sliding movement while keeping slide body 72 connected to slide housing 76. Spring 74 is mounted between end wall 76b of slide housing 70 and end 86 of slide body 72 to bias the slide body towards end wall 76a. Once assembled, and as shown in FIG. 7, housing 70 of slide mechanism 52 is mounted to lower portion 40a of pane 40 using adhesives or other known fastening techniques. It should be noted that slide mechanisms 52 are mounted on pane 40 such that cam surface 89 is aligned with cam member 54 and slot 116 is aligned with pin 60 for each respective cam body 50.

As window 32 is detachable from gate 30, the window may be either preassembled to the gate and then installed on the vehicle, or window 32 may be first mounted to vehicle 10 with the upper inside peripheral edges of pane 40 located in channel portion 24 and the window locked in place with pins 88. The pins are biased by spring 74 into and engaged with strikers (not shown), which are well-known and located in peripheral frame 18.

Regulator assembly 34 is preassembled within gate 30, and the gate is mounted to peripheral frame 18 using a pivotal connection at the lower end of the gate.

In operation, gate assembly 15 provides multiple configurations for vehicle 10 as shown in FIGS. 1-4. For instance, when gate 30 is latched in the upright position as shown in FIGS. 1 and 2, window 32 is movable to an upper extended position as shown in FIG. 1 sealing passenger compartment 14 from cargo compartment 12. The window may also be lowered and retracted using regulator assembly 34 within gate 30 either partially or completely as shown in FIG. 2 to allow ventilation through window portion opening 20. Gate assembly 15 may also be moved to the position shown in FIG. 3 wherein window 32 is retracted within gate 30, and the latches on the gate are released so that the gate is pivoted to the down position. Alternately, gate assembly 15 may be reconfigured as shown in FIG. 4, wherein window 32 is extended out from and detached from gate 30. In this configuration, gate 30 is unlatched and pivoted to the down position similar to FIG. 3; however, the attachment mechanism has detached and secured window 32 into channel portion 24. These various positions of the window can be obtained using regulator assembly 34 and attachment mechanisms 36 without the need to manually raise, lower or detach the window from the gate. It should be noted that both attachment mechanisms 36 function in a similar manner, so that the operation, as discussed below, need only be described for one.

Window 32 is attached to gate 30 and raises and lowers with slides 44 of regulator system 34 when each cam body 50 is locked with the corresponding slide mechanism 52 as shown in FIGS. 8A and 9A. In this position, locking feature 85 is engaged with receiving profile 93 of island 92. This prevents compression spring 74 from pushing slide body 72 further to the right where pin 88 is engageable with a striker in peripheral frame 18. Also in this position, as best shown in FIG. 9A, the enlarged head 69 of pin 60 will be positioned over the narrow portion 120 of slot 116 locking coupling unit 56 to receiving portion 114. Therefore, as slide 44 and cam body 50 move down, the pin head will also pull slide mechanism 52 and attached pane 40 down. Furthermore, when attachment mechanism 36 is in this locked position and slide 44/cam body 50 move upward, guide washer 64, as biased by, spring 62 will also push slide body 72 and window pane 40 upward.

To detach the glass from regulator system 34 and gate 30, slides 44 are raised by the regulator system to move pane 40 to the extended position. Pane 40 will then reach an uppermost stopping point wherein it is engaged in channel 24, at which point the pane will stop moving. Slides 44, however, will continue to move upward, and cam member 54 of cam body 50 will contact cam surface 89 of slide body 72 to force the slide body toward end wall 76b. The pane 40 will be detached by way of the interaction between island 92 and pivot arm 80.

Continued upward movement of cam 54 causes spring 74 to compress further, and island 92 will move away from locking feature 85, which will be temporarily directed into channel 112, as shown in FIG. 9B. The movement of locking feature 85 into channel 112 is facilitated by the relative movement of slide member 72 to housing 70 from which the locking feature is pivotally attach by pivot arm 80. Island 92 and extension 110 will move with the slide body toward end wall 76b so that the angled front end of extension 110 will contact the angled side of triangular-shaped locking feature 85 and force the locking feature downward. The pivotal movement of the locking feature 85 about pivot 81 is what enables the locking feature to move downward, and continued movement of slide body 72 moves channel 112 around the locking feature. Also, as slide body 72 moves toward end wall 76b, pin 60 will move towards the closed end of narrow portion 120 of slot 116 (FIG. 9B). Pin 60 and head 69 will also move further into slide body 72 as cam member 54 goes toward the bottom of cam surface 89 compressing spring 62 (FIG. 8B).

At this point, slides 44 will have reached the full upward position, and regulator system 34 will now cause slides 44 to move in a downward direction. As each slide 44 and cam body 50 moves downward, cam member 54 will move back down cam surface 89 allowing spring 74 to push slide body 72 toward end wall 76a. As slide body 72 continues to move toward end wall 76a, locking feature 85 will move up ramp 95 to upper end 96 as shown in FIG. 9C. Also, as slide body 72 moves toward end wall 76a, slot 116 moves forward so that head 69 of pin 60 is aligned with wider portion 118. Additionally, pin 82 on slide body 72 will have moved outward to engage the striker on peripheral frame 18, locking window 32 in place. Accordingly, as slides 44 continue in a downward movement, head 69 of pin 60 will become disengaged from slot 116 (FIGS. 8C, 9C) separating cam body 50 from slide body 52 and detaching window 32 from gate 30. At this point gate 30 can be lowered while window 32 remains covering window portion opening 20, corresponding to the configuration of FIG. 4.

To reattach window 32 to gate 30, slides 44 are moved in an upward direction by regulator system 34. As cam body 50 moves near slide body 72, head 69 of pin 60 enters wider portion 118 of slot 116 on receiving portion 114. Then, as cam body 50 continues to move upward, guide washer 64 contacts receiving portion 114 and begins to compress spring 62. Also, cam member 54 starts to contact cam surface 89, and slide body 72 begins to move back towards end wall 76b thereby compressing spring 74. As slide body 72 continues to move back, locking feature 85 on pivot arm 80 moves off of upper end 96 of ramp 95 and travels around island 92 and into channel 110 as indicated by the arrows in FIG. 9A. The wedge shape of island 92 and angle on angled extension 108 direct locking feature 85 into channel 110. It should be noted that the point of the wedge on island 92 should be slightly lower than the upper end 96 of ramp 95 so that the corner of locking feature 85 does not get caught below island 92 while the slide body is moving back towards end wall 76b. The upward movement of the slide will again stop upon reaching the uppermost position, and then of regulator system 34 will start to move the slide back downward. As the slide 44 move back down, locking feature 85 will move back into receiving profile 93 of island 92 as shown in FIG. 9A. In this position, slide mechanism 52 will again be locked to cam body 50 as head 69 will be positioned over narrower portion 120 of slot 116. Also, as the locking feature is engaged with the receiving profile of island 92, slide body 72 will be compressing spring 74 to prevent pin 88 from locking with the striker on peripheral frame 18. Accordingly, window 32 will be reattached to gate 30 and will again move up and down with slides 44.

While the invention has been taught with specific reference to the described embodiments, one skilled in the art will recognize that changes can be made in form and detail without departing from the spirit and scope of the invention. For example, cam surface 89 on slide body 72 may be placed on a projection extending outward from side 90 instead of being an inwardly extending recess. When cam surface 89 is placed on a projection, cam 54 may also be a projection or a recess with a cam surface may be placed into upper end 57 of cam body 50. The slope or shape of the cam member and cam surfaces may also be changed to any that will provide the relative movement of the slide body to the slide housing and cam body.

In addition, the configuration of the island in receiving portion may be varied as well as the configuration of the locking feature to any that will provide the locking and release operation with the movement of slide body 72. Furthermore, the movement of the slide body may be accomplished using an independent motor instead of the cam movement described. This would alleviate the need to have the island and locking feature engagement. Also, although the above described embodiment shows two attachment mechanisms, the invention may also be carried out using only one. If only one attachment mechanism is used, the window may be locked to only one side of the peripheral frame, or a linkage may be employed so that movement of a single slide body causes an engagement member at each side of the window to lock with the frame. As such, the described the embodiments are to be considered in all respects only as illustrative and not restrictive. The scope of the invention is therefore, indicated by the following claims rather than by the drawings or description.

What is claimed is:

1. A gate assembly for a vehicle comprising:
a gate;
a window having a pane that is retractable within said gate; and
an attachment mechanism releasable attaching said window to said gate, said gate assembly having a first position, wherein said gate is upright and said window is attached to said gate, a second position wherein said gate is down and said window is attached to said gate, and a third position wherein said gate is down and said window is detached from said gate and located in a window opening in the vehicle.

2. The gate assembly of claim 1, wherein said window includes a frame.

3. The gate assembly of claim 2, wherein said pane is extended above said gate in said first position to cover a window opening in the vehicle.

4. The gate assembly of claim 3; further including a fourth position wherein said gate is upright, said window is attached to said gate, and said pane is retracted within said gate.

5. The gate assembly of claim 1, further including a regulator system that moves said pane from a retracted position within said gate to an extended position extending above said gate.

6. The gate assembly of claim 5, wherein said regulator system includes a slide and said attachment mechanism includes a cam body connected to said slide.

7. The gate assembly of claim 6, wherein said cam body includes a cam member and a coupling unit.

8. The gate assembly of claim 7, wherein said coupling unit includes a resilient member.

9. The gate assembly of claim 8, wherein said attachment mechanism further includes a slide mechanism connected to said window, said slide mechanism including a cam surface that mates with said cam member and a receiving portion engageable with said coupling unit.

10. The gate assembly of claim 9, wherein said slide mechanism further includes an engagement member that secures said window in said third position, said cam member providing movement to said engagement member and moving said receiving portion relative to said coupling unit.

11. The gate assembly of claim 10, wherein when said slide of said regulator system moves upward, said cam member moves said engagement member into place securing said window in said third position, and after said slide moves downward, a subsequent upward movement of said slide causes said cam member to retract said engagement member and engage said coupling unit with said receiving portion.

12. The gate assembly of claim 1, wherein said attachment mechanism further includes a slide mechanism connected to said window, said slide mechanism having an engagement member that secures said window in said third position.

13. The gate assembly of claim 12, wherein said engagement member is biased by a resilient member to lock with a frame member of the vehicle to secure said window in said third position.

14. The gate assembly of claim 12, wherein said slide mechanism further includes a pivot arm and a catch member, said window being attached to said gate when said pivot arm is engaged with said catch member, and said window being releasable from said gate when said pivot arm is disengaged from said catch member.

15. The gate assembly of claim 13, wherein said engagement member is disengaged from the frame member of the vehicle when said pivot arm is engaged with said catch member.

16. A gate assembly for a vehicle comprising:
a gate;
a window having a pane that is retractable within the gate; and
an attachment mechanism releasably attaching said window to said gate, said attachment mechanism including a slide mechanism having a slide body movable between one position attaching said window to said gate to an other position wherein said window is detached from said gate and said slide body is engaged with the vehicle.

17. The gate assembly of claim 16, wherein said slide body is biased by a resilient member to said other position wherein said window is detached from said gate.

18. The gate assembly of claim 16, wherein said slide mechanism further includes a housing having a pivot arm attached thereto and said slide body includes a catch member, said pivot arm engaged with said catch member when said slide body is in said one position wherein said window is attached to said gate, and said pivot arm is disengaged from said catch member when said slide body is in said other position wherein said window is detached from said gate.

19. The gate assembly of claim 16, further including a regulator system having a slide, and said attachment mechanism includes a cam body attached to said slide.

20. The gate assembly of claim 19, wherein said cam body includes a cam member and said slide body includes a cam surface, said cam member engaging said cam surface to move said slide body between said positions.

21. The gate assembly of claim 20, wherein said cam body further includes a coupling unit and said slide body includes a receiving portion engageable with said coupling unit to secure said window to said gate.

22. The gate assembly of claim 21, wherein said coupling unit includes a resilient member.

23. The gate assembly of claim 21, wherein said coupling unit includes a pin having an enlarged head and said receiving portion includes a keyhole-shaped slot having a wider portion and a narrower portion, said head on said pin fitting through said wider portion but not said narrower portion.

24. A gate assembly for a vehicle comprising:
a gate;
a window having a pane that is retractable within said gate;
a regulator having a slide that drives movement of said window; and
an attachment mechanism releasably attaching said window to said gate, said attachment mechanism including a cam body connected to said slide, said cam body having a cam member causing said window to detach from said gate when said slide is moved.

25. The gate assembly of claim 24, wherein a subsequent movement of said cam member causes said window to reattach to said gate.

26. The gate assembly of claim 25, wherein both of said movements of said cam member to detach and to reattach said window to said gate are in an upward direction.

27. The gate assembly of claim 24, wherein the cam body further includes a coupling unit attaching said window to said gate.

28. The gate assembly of claim 27, wherein said coupling unit includes a resilient member.

29. The gate assembly of claim 27, wherein said attachment mechanism further includes a slide mechanism with a slide body, said slide body having a cam surface configured to mate with said cam member and a receiving portion that is engageable with said coupling unit.

30. The gate assembly of claim 29, wherein said slide mechanism further includes an engagement member on said slide body and a resilient member biasing said engagement member to engage a frame on the vehicle.

31. The gate assembly of claim 30, wherein said slide mechanism further includes a pivot arm mounted on a housing and a catch member on said slide body, said pivot arm and catch member being engageable to prevent said engagement member from engaging the frame on the vehicle.

32. A gate assembly for a vehicle comprising:
a gate;
a retractable window; and
an attachment mechanism releasable attaching said window to said gate, said attachment mechanism including a slide mechanism with a slide body having an engagement member, said slide body movable between one position where said engagement member is engaged with the vehicle to secure said window in an opening of the vehicle and another position wherein said engagement member is disengaged from the vehicle with said window being movable relative to the vehicle.
